(19) United States
(12) Patent Application Publication
(10) Pub. No.: US 2005/0076123 A1
(43) Pub. Date: Apr. 7, 2005

(54) Resource balancing in distributed peer to peer networks

(76) Inventor: Youssef Hamadi, Cambridge (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/891,262

(22) Filed: Jul. 14, 2004

(30) Foreign Application Priority Data
Jul. 15, 2003 (GB) 0316476.1

(51) Int. Cl. G06F 15/173; G06F 15/167

(52) U.S. Cl. 709/226; 709/213

(57) ABSTRACT

A method of balancing resources between a plurality of peer computer entities in a network of said plurality of peer to peer computer entities comprises: determining an amount of a resource, which said local peer computer entity already holds; determining an amount of said resource which is held on a neighbouring said peer computing entity; said local peer computer entity assessing a difference between said locally held resource and said amount of resource held on said neighbouring peer computer entity; and whether to initiate a transfer of resource between said local peer computer entity and said neighbouring peer computer entity.

### FIELD OF THE INVENTION

The present invention relates to the field of computer science, and particularly to peer to peer connected networks of computer entities

### BACKGROUND TO THE INVENTION

A distributed peer to peer network comprises a plurality of computer entities, connected by a set of point to point communications links. Each computer entity operates a peer to peer connection protocol, which allows each computer entity to communicate on a point to point basis with a plurality of other computer entities of the network.

Referring to FIG. 1 herein, there is illustrated schematically a simple example of a network of computer entities arranged on the peer to peer basis. Each of a plurality of computer entities 100-103 communicates with one or more other computer entities within the network, and can act either as a client to any other computer entity in the network, and/or as a server to another computer entity. Each computer entity therefore has two modes of operation, firstly acting as a client, where for example it may access data on another computer entity in the network, or secondly acting as a server, in which case another computer entity may access data stored on the computer entity itself. In a general case of a peer to peer environment of connected computer entities, each computer entity represents topologically a node in the network. Connections between nodes can be arbitrary in the general case.

Several protocols are known in the prior art for establishing a network connectivity between computer entities on the peer to peer basis. One of these is the known Gnutella protocol, available since early 2000, however, there are other known peer to peer protocols.

In the prior art peer to peer networks, each computer in the network is capable of providing a set of resources to the network. The resources fall into two categories: those which are local to a computer entity itself, for example data storage capacity or data processing capacity, on a local printing capability, and secondly, those resources which can be transferred to another peer computer, for example a data file, on an application program.

In a prior art peer to peer network, the topology of the network is not centrally controlled. Computer entities can join or leave the network independently of each other, and this provides one of the main advantages of a peer to peer network, which is its scalability. However, because there is no centralized control or supervision in the network, distributed peer to peer networks can suffer from the problem that resources are unevenly distributed throughout the network, with high concentrations of resources existing on some computer entities, whilst other computer entities have few resources.

Referring to FIG. 2 herein, there is illustrated schematically an example of a peer to peer network in which a plurality of computer entities are each represented as nodes in the network, connected by a plurality of communications links, in which the problem of unbalanced distribution of resources is illustrated. A first computer entity A may have 500 files of a particular type, for example .mp3 files, whilst the neighboring computer B may have fewer files, for example 20, as may a further neighboring computer C.

Unbalanced distribution of resources on a network is non-optimal for the following reasons:

Firstly, computers which have a large amount of resource can become overloaded.

Secondly, if a computer which has a large amount of resource fails or is removed from the network, then a large amount of resource is lost from the network in one event.

Prior art distributed file systems have solutions to cope with low latency and poor availability of resources. These systems use both centralized network file system like technologies and distributed technologies. However, the requirements for distributed file systems are more critical than in peer to peer file sharing. Distributed file systems must ensure file consistency, conflict resolution during file updates, and distributed path traversal, i.e. moving into a directory structure distributed between several hosts. On the contrary, the problem of file sharing in peer to peer networks is more specific. After being downloaded to a peer computer entity, a file has its own life independently of any other files or any other potential updates to the file which may occur to the original file on the original peer computer. Peer to peer networks in general do not have to deal with file consistency, conflict resolution and path traversal. Consequently, the prior solutions for distributed file systems for coping with low latency and poor availability are unsuited to peer to peer file sharing technology.

In prior art peer to peer networks, when a resource such as a file is downloaded, balancing of resources does occur to a limited extent within the network, since the resource becomes available on more than one computer. However, this is a side effect of resource sharing, and is not regulated or controlled in prior art peer to peer networks.

### SUMMARY OF THE INVENTION

According to a first aspect of the present invention there is provided a method of balancing resources between a plurality of peer computer entities in a network comprising said plurality of peer to peer computer entities, said method comprising:

determining an amount of a selected resource which said local peer computer entity already holds;

determining an amount of a resource which is held on a neighbouring said peer computing entity;

assessing a difference between said amount of said locally held resource and said amount of resource held on said neighbouring peer computer entity; and

determining whether to initiate a transfer of resource between said local peer computer entity and said neighbouring peer computer entity.

Other aspects of the invention are as recited in the claims herein and the scope of the invention is defined solely by the features of the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a prior art network of computers connected according to a known peer to peer architecture;

FIG. 2 illustrates schematically a prior art network of peer to peer connected computer entities represented as a set of nodes and communication links between the nodes, showing an imbalance of resource residing at individual peer computers within the network;

FIG. 3 illustrates schematically a peer to peer connected network of computer entities illustrated in the form of nodes and communications links, having a more balanced deployment of resources, after transfer of resources according to a specific method according to the present invention;

FIG. 4 illustrates schematically components of a peer computer entity capable of balancing its own resources with those of other connected peer computer entities, according to a specific embodiment of the present invention;

FIG. 5 illustrates schematically components of a balancing program which enables the computer entity of FIG. 4 to operate balancing of its resources with other peer computer entities;

FIG. 6 illustrates schematically process steps carried out by a local peer computer for determining whether it should transfer resources between itself and a neighboring peer computer entity;

FIG. 7 illustrates schematically processes carried out by a local peer computer for determining information about a neighboring peer computer;

FIG. 8 illustrates schematically process steps carried out by a local peer computer entity for storing-information for describing a status of a neighboring peer entity; and

FIG. 9 illustrates schematically process steps carried out by a neighboring peer entity for determining whether to accept or reject a transfer of resources with a local peer computer entity:

FIG. 10 illustrates schematically a simple network of three computer entities to illustrate a proof that stabilization of the resource balancing protocol must occur;

FIG. 11 illustrates schematically an initial state of a network of peer to peer connected computer entities, showing imbalances in resource distribution, before application of a protocol as described herein;

FIG. 12 illustrates schematically the network of FIG. 11 after application of the protocol described herein, in which resources are more evenly balanced throughout the network;

FIG. 13 illustrates schematically simple case of 3 computer entity nodes in a network, showing an imbalance of files between those 3 nodes after a second application of a protocol between of pair of the three computer entities;

FIG. 14 illustrates schematically a file resource allocation amongst the 3 computer entities of FIG. 13, after a third application of the protocol between a pair of the computer entities; and

FIG. 15 illustrates schematically messages sent between the 3 computer entities of the network of FIG. 13, at an initial state, and illustrates application of the protocol at each of the 3 computer entities.

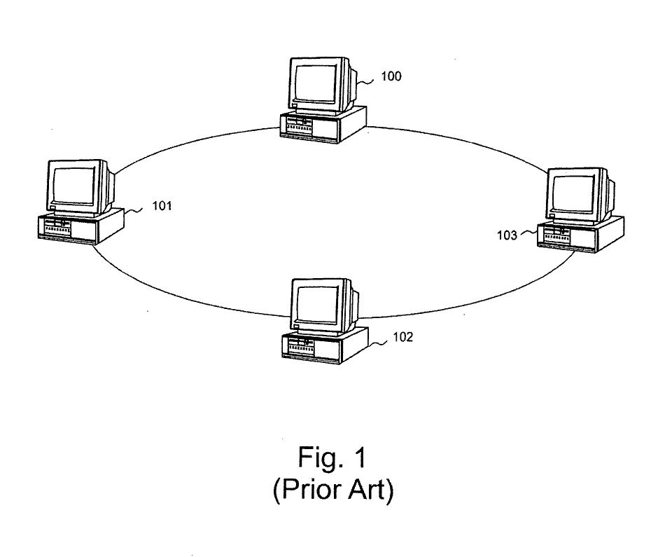

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

In this specification, the term ‘computer entity’ is used to mean a component of computing functionality which includes a computing resource; and a communications means for communicating with one or a plurality of other computing entities. A computer entity may comprise a computer platform, for example a personal computer (PC) Macintosh® computer or the like, or may comprise a stand alone ‘appliance’ type computer device, for example a data storage device or the like, or may comprise a computer peripheral device.

In this specification, the term ‘distributed’ when used in the context of a distributed peer to peer network, means that each computer entity can communicate logically with one or more other computer entities within the network, on a basis which is independent of physical location. A distributed network can mean a local area network, or a wide area network, or a plurality of computers connected via a peer to peer protocol globally, for example over the internet. A distributed peer to peer network may be a “closed” network, in which entry into the peer network is restricted, for example restricted to computers operating or owned by a single organization or business entity, or the network can be an “open” network, in which peer computers may be owned or operated by different owners or legal entities. Closed networks may be protected by a firewall, but not necessarily.

In this specification, the term ‘resource’ is used to mean an element of functionality which is provided by a computer entity. Resources can be of two types: either transferable or non-transferable. Transferable resources include items which can be transferred from one computer entity to another over a communications link, for example a data file, or an application program in the form of application data. Non-transferable resources comprise resources which are physically bound to a computer entity, such as hard disk data storage space, data processing power or the like. Resources may include data content, for example image data file, music data file, text files or the like.

In this specification, the term ‘neighboring’ refers to a computer entity which can be connected to a local computer entity by one or more communications links in a peer to peer communications network, where individual computer entities act as nodes in the network, and individual peer computer entities within the network are connected together by a plurality of links. A neighboring computer entity may be connectable to a local computer entity via one or more intermediate nodes, or. may be connected directly to the local computer entity by a communications link.

A communications link may comprise a direct local area network, wide area network connection, or an internet connection, for example via one or more gateway computers on the World Wide Web.

Specific implementations according to the present invention aim to provide a protocol which is executable between peer computers, for balancing transferable resources between peer computer entities within a peer to peer network, particularly a distributed peer to peer network.

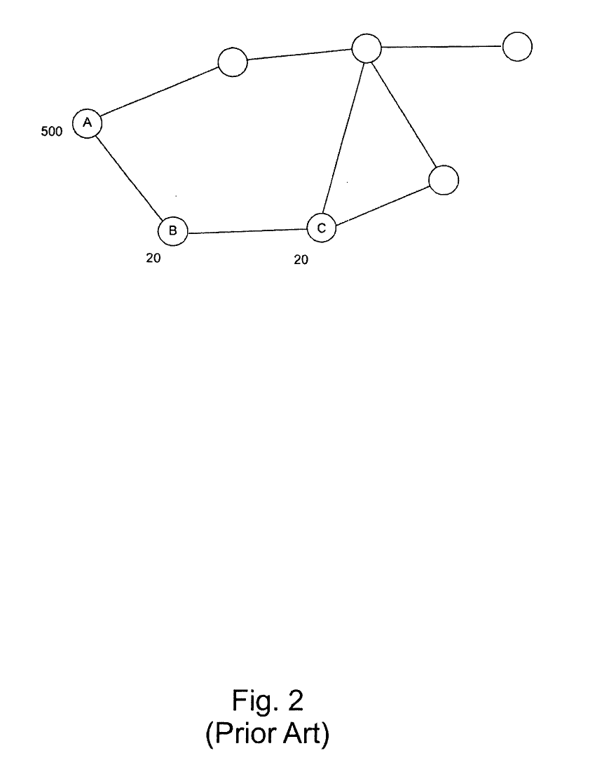

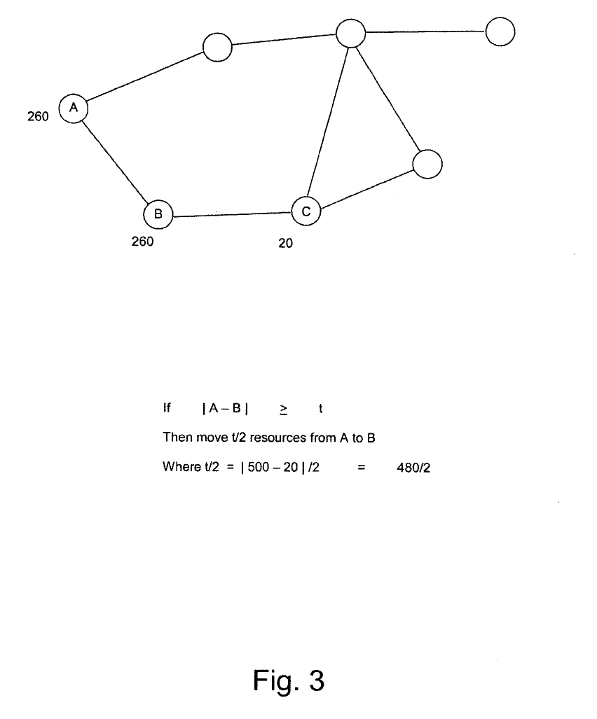

For example, taking a network having an initial file distribution as shown in FIG. 2 herein, after operation of such a protocol, a file distribution as illustrated in FIG. 3 herein may be achieved, in which first and second computers A, B respectively have balanced the number of files stored on those two computers, such that the imbalance between the number of files stored on each computer is reduced, and in the case shown, such that each computer A, B stores the same number of files.

In the example shown in FIG. 3, starting with the initial file distribution as shown in FIG. 2, where a first computer entity A stores 500 files and the second computer entity B stores 20 files, the protocol applies the following logic:
|A−B|≧t

Then, an amount t/2 of file resources are moved from first computer entity A to second computer entity B.

In the example of FIG. 3 the number of files transferred is calculated as;
|500−20|=480/2=240

In the example of FIG. 3, this results in 260 files being stored on each of the first and second computers A, B after operation of the resource balancing protocol.

Typically, the protocol may be of use in a closed distributed peer to peer network, for example within a single corporation, where all computer entities in the network are owned or operated by the same organization, and so from the organizations point or view, there are no restrictions, for example file confidentiality restrictions, on the movement of resources around the network.

In order to operate the protocol, several conditions should be met as follows:

Each peer computer in the network has access to information on the amount of resources available at neighboring peer computers.

Each peer computer has the capability to calculate an ‘imbalance factor’, between the amount of resources at that peer computer, and the amount of resources available at a neighboring peer computer.

Each peer computer is provided with a capability to transfer resources between itself and a neighboring computer.

In general, the rules of the protocol are as follows:

The protocol checks for an imbalance factor between two peers in a network.

If there is an imbalance between resources between two different peers in a network, then the extent of this imbalance is compared with a threshold value.

If the imbalance of resources between two peer computers exceeds the threshold, then a transfer of resources between the computer entity having the lower amount of resource and the computer entity having the higher amount of resource is made.

Computer entities which have relatively lower amount of resource than other neighboring computer entities seek to increase the amount of resources which they hold, thereby increasing their contribution to the network by providing a store of resources.

Transfer of resources may be by duplication of that resource, i.e. copying of the resource from one computer to another, or may be by full transfer of a resource from one computer to another, where the original resource does not remain on the original computer but is transferred onto another computer.

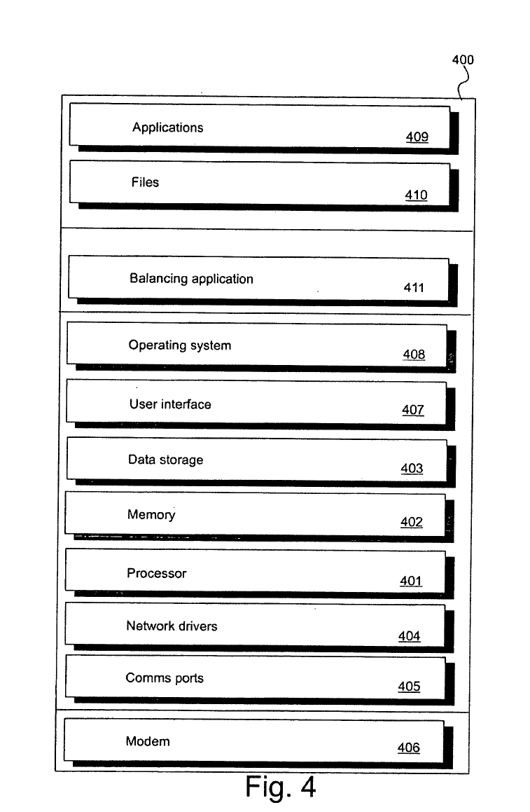

Referring to FIG. 4 herein there is illustrated schematically components of a computer entity within a distributed peer to peer network enabled for resource balancing according to a specific embodiment of the present invention. The computer entity 400 comprises: a processor 401; an associated memory 402; a data storage device 403, for example a hard disk drive or the like; one or more network drivers 404 for communicating with other computers on a network; one or more communications ports 405 connecting to a local area network, wide area network or the like, for communicating with other computer entities; optionally, one or more modems 406 for communicating with other computers; a user interface 407 for example the known Windows 2000®, Windows NT®, Linux® or Unix®, operating systems; a set of applications 409, the applications being stored as program data, and being transferable between peer computer entities; a plurality of files 410, stored as file data, the file data being a resource which is transferable between computer entities; and a balancing protocol application 411 for implementing the file balancing protocol and for implementing transfer of files between computer entities.

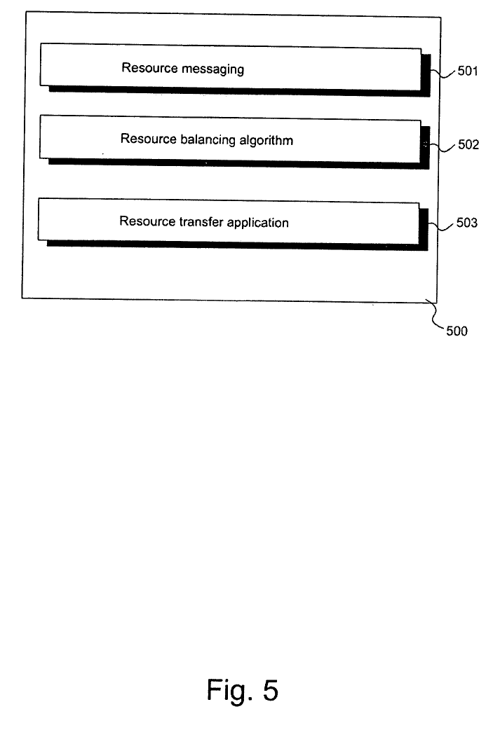

Referring to FIG. 5 herein, there is illustrated schematically functionality provided to a peer computer, in the form of one or more computer programs, for implementing the file balancing protocol as described herein. The program comprises a resource messaging component 501 for receiving information about available resources on neighboring peer computers, and transmitting information about resources available on local peer computer on which the program is installed; a resource balancing algorithm component 502 for determining whether a transfer of resources between the local peer computer, and a neighboring peer computer should be made; and a resource transfer application 503 for implementing a transfer of resources between peer computer entities.

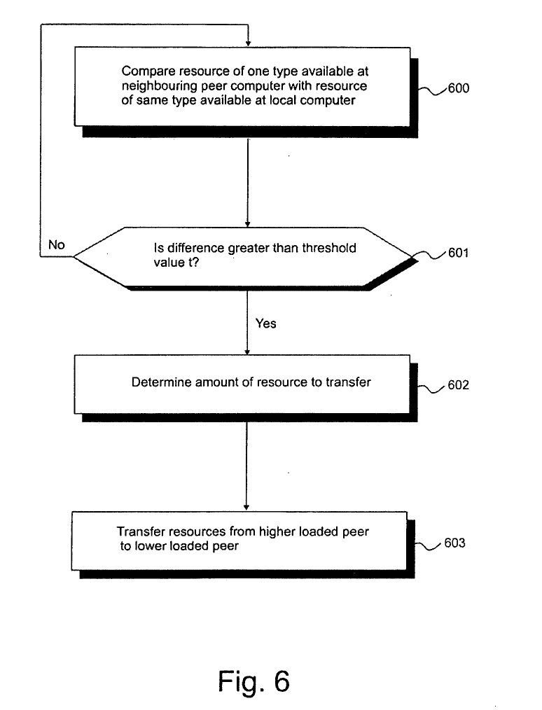

Referring to FIG. 6 herein there is illustrated schematically operation of a peer computer for comparing its own resources with resources of each of a plurality of neighboring peer computers in turn. Comparison of resources operates continuously as a background operation, or at periodic intervals, for applying resource balancing between the local peer computer and its neighboring peer computers. In process 600, the balancing application 500, having received and sent resource messages via the resource messaging component 501, compares the resources of a particular selected type available at a selected neighboring peer computer, with the amount of resources of the same type which are available at the local computer. The local peer computer determines a difference between the resources available at the neighboring computer with the locally available resource and determines whether the difference is greater than a threshold value t. If the difference between the available resources at the two computers is less than the threshold value t, then no transfer of resources is made, and the local computer proceeds to examine a next neighboring computer. However, if the difference between the resources available at each of the two computers is above a threshold value t, in process 601, then in process 602 the local computer determines the amount of the resource to be transferred either from the local computer to the neighboring computer, or from the neighboring to the local computer. In process 603, the local computer initiates a transfer of resources between the neighboring computer and the local computer. This may be achieved by the local computer sending a request message to the neighboring computer requesting files to be transferred from the neighboring to the local computer, or by sending a file transfer message, requesting transfer of a quantity of resources from the local computer, to the neighboring computer.

The actual transfer of resources in implemented by a conventional resource transfer protocol, for example a file transfer protocol in the case of transferring files.

Each local peer computer entity can operate in two modes. Firstly, the peer computer can find that it has more files than neighbour, in which case a transfer of files from the higher loaded computer to the lower computer can take place. Secondly, if the peer computer finds that it has relatively fewer files than a neighboring computer, the local computer can request a transfer of files from the higher loaded neighboring computer, to itself. In a best mode implementation, each local peer computer is actively seeking to increase its holding of its resources, subject to a balancing out of resources across the network, which is controlled by setting the threshold value t.

The threshold value t for each computer entity may be different from computer entities. Further, for each type of resource, a different parameter t may be stored, so that simultaneously, for each of a plurality of different resources, the computer entity may seek to balance each of those resources against the resources resident on neighboring computers.

The threshold value for each neighboring peer has to be negotiated locally at the local peer computer during an initial connected step between the local computer and the neighboring computer. The threshold value t assigned to a particular neighboring computer by the local computer takes into account the neighboring computers data storage capacity, local bit rate capacity of connections to the neighboring computer, and assumed availability of resources.

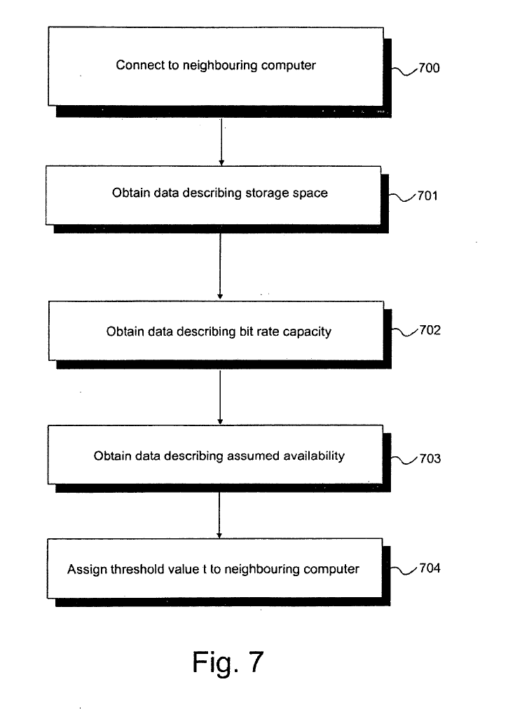

Referring to FIG. 7 herein, there is illustrated schematically steps carried out by the balancing application for assigning a threshold value t to a neighboring peer computer. In process 700, the local computer connects to a neighboring peer computer. In process 701 the local computer obtains data describing storage space at the neighboring computer. In process 702, the local computer obtains data describing a bit rate capacity of the connection into and out of the neighboring computer. In process 703, the local computer obtains data describing an assumed availability of capacity of the neighboring computer to accept a transfer of resources. In step 704, the local computer assigns a threshold value t to the neighboring computer, based upon an algorithm which takes into account the parameters of data storage space, bit rate capacity and availability of resources at the neighboring computer.

In process 703, in order to cope with asynchronous behaviors, each time the local peer finds a neighboring acquaintance computer eligible to receive a part of its shared files, it creates an upload message, to which it adds beliefs about values describing the neighboring peer.

In process 704, the local computer assigns a threshold value t to a neighboring computer which governs the resource transfer relationship between the neighboring computer and the local computer from the local computers point of view. Depending upon how the value of threshold t is set, the local computer will attempt to upload a lesser or greater number of resources from the neighboring computer, or conversely, request that the neighboring computer receives resources from the local computer.

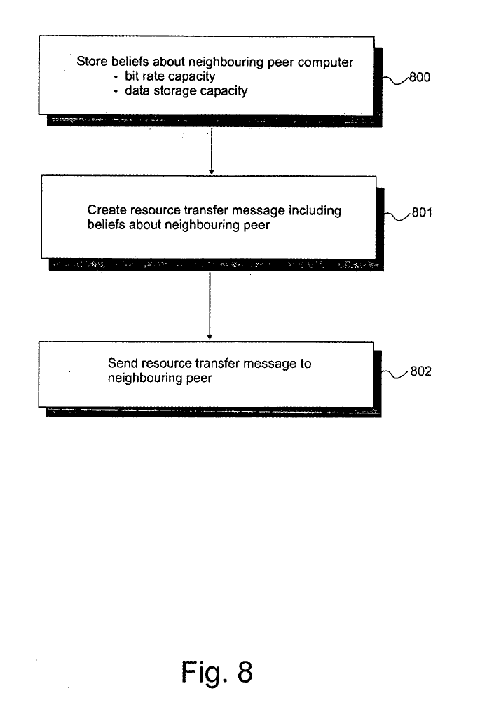

Referring to FIG. 8 herein, in process 800, when a local peer computer connects to a neighboring peer computer and obtains data describing values about that neighboring peer computer such as bit rate capacity, data storage capacity and assumed availability, it stores in a local database values of those parameters, assigned to an address of that neighboring peer. In process 801, when a resources transfer message is generated for transfer of resources from the local computer to the neighboring peer computer, the local computer adds to the resource transfer message, the status values of the parameters of the peer computer which are stored in the belief table. This represents the local computers knowledge of the status of the neighboring peer computer. In process 802, the local computer sends the resource message, including the belief data to the neighboring peer computer.

In a case where the neighboring peer computer has changed its status since it last communicated with the local computer, the local computer may be attempting to send resources to the neighboring computer, in the belief that the neighboring peer computer can accept those resources. However, in the meantime, the neighboring computer's status may have changed, due to interaction with a further peer computer, so it is possible due to the asynchronous nature of communications between the peer computers, that the local computer is attempting to send resources to the neighboring computer based on the false information that the neighboring computer is capable of accepting those resources. Inclusion of the belief data in the resource transfer message from the local computer enables the neighboring peer computer to assess whether is it capable of receiving the resources requested by the local computer, to be transferred from the local computer entity.

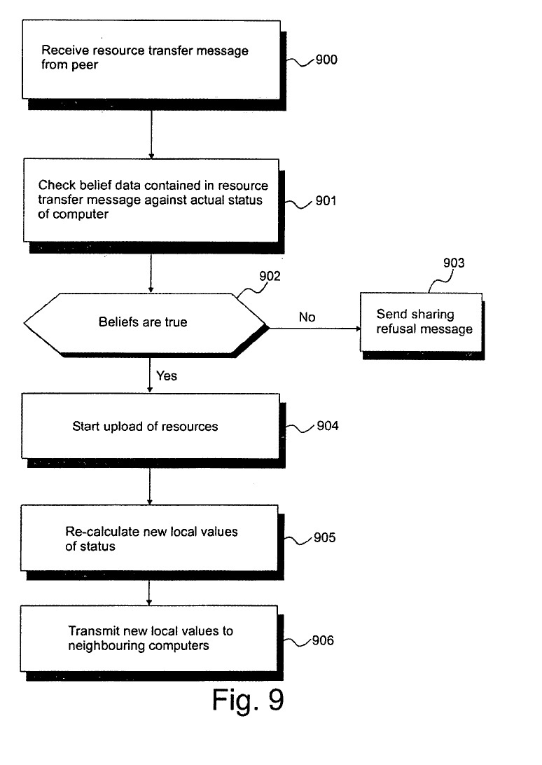

Referring to FIG. 9 herein, there is illustrated schematically steps carried out by the neighboring computer upon receiving a resource transfer message from the local peer computer. In process 900, the resource transfer message from the local computer is received by the neighboring peer computer. In process 901, the neighboring computer checks the status belief data contained in the resource transfer message which is data about the neighboring computer which the local computer holds, against the actual status of the neighboring computer. In process 902, the neighboring computer determines whether the belief data stored in the resource transfer message matches, or is within acceptable limits of the true status of the neighboring computer. If not, then this indicates that the neighboring computer may not be able to handle the resources to be transferred from the local computer once it receives them, in which case in step 903, the neighboring computer returns a resources transfer refusal message back to the local computer. However, if in process 902 the neighboring computer determines that the belief data received in the resource transfer message does match within acceptable limits, the true status of the neighboring computer, then an upload of resources is commenced in process 904. In process 905, the neighboring computer then recalculates its new local values of status, such as bit rate capacity, data storage capacity, and in process 906 transmits those new values to all neighboring computers for which it stores connection information.

Consequently, upon receiving a resource transfer message, a neighboring computer will check whether it is capable of receiving those resources, and if so determine the effect on its new status and capability for receiving further resources. This information is then retransmitted to neighboring peer computers, so that the information on the new status of the neighboring computer is propagated to its immediate neighbours.

When a network is initially created, or when a new peer compute enters a network, or when any other change in network resources occurs, for example by a user adding resources to a computer within the network, the protocol sets of a chain of asynchronous resource balancing events between individual peer computers within the network. The overall process of the plurality of balancing events can be shown to tend towards a stable state as follows.

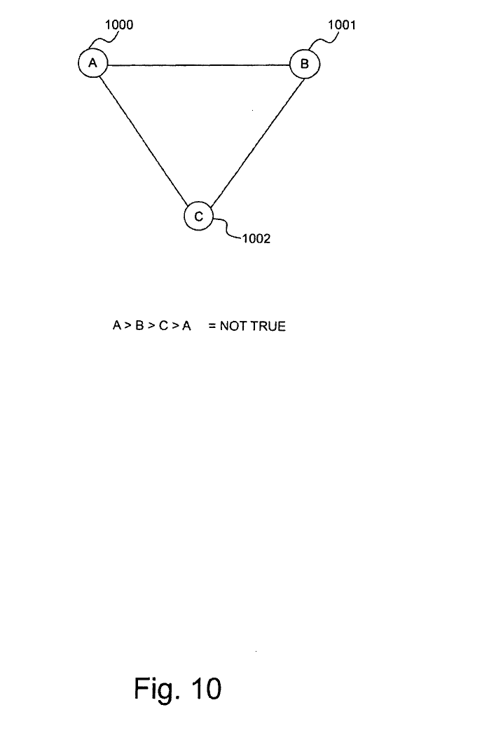

Referring to FIG. 10 herein, considering a simple network of three computer at node A, B, C respectively, if the protocol did not stabilize itself over a period of time, then the amounts of resources A, B, C respectively at the first to third computers 1000, 1001, 1002 would result in the condition A>B>C>A, which is impossible. Therefore, because that condition A>B>C>A is impossible, the protocol must tend towards a stable state.

Referring to FIG. 11 herein, there is shown an illustration of a peer to peer network represented as a set of nodes and links, in which an amount of a resource stored at each node is represented as a number within a circle, and a relative imbalance between a node and its neighboring node is shown as a number written next to a link between those two nodes. In the example of FIG. 11, a universally applicable threshold value t=10 is assumed at each computer, and it is assumed that each peer computer has efficient storage space and band width to accept more resources, for example files. That is, all peer computers have agreed locally with each other they can accept more files.

In the network of FIG. 11, the file distribution is relatively unbalanced. There are imbalances of up to 60 files between 2 neighboring computers, and a computer storing a highest number of files (90) stores 30 times more files than the computer storing the lowest number of files (3 files). This causes a high latency within the network, since file look ups in the network take longer. For example for a search for a particular file which is resident on the computer having the highest number of files where the search starts on the computer having the lowest number of files needs to traverse across for intermediate computers, before accessing that file resource. A search process for finding that file takes a relatively long time to propagate. Further, the distribution of resources in the network raises the prospect of poor availability of resources. For example, if the computer storing the highest amount of files is shut down or disconnected, the network as a whole loses 90 files, which represents 50% of the files on the network.

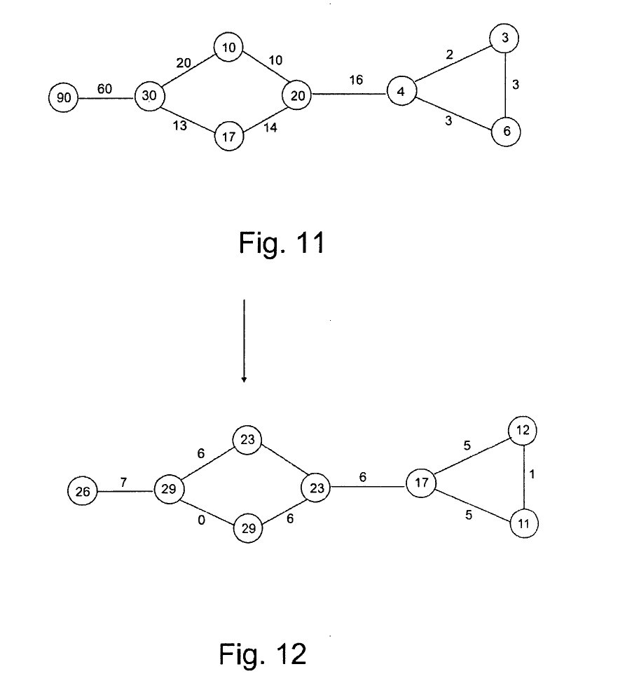

Referring to FIG. 12 herein, there is illustrated schematically, the same network, after application of the protocol, once the network has settled into a steady state. In this example, the protocol allows transfer of files without any copying, so the files are not duplicated. After balancing of resources across the network by the protocol, a disparity between the number of files on each computer is reduced. In the case shown the highest number of files stored on a single computer is 36, whereas the lowest number of files stored on a computer is 11. Since the imbalance factor between each pair of immediately adjacent connected nodes is less than the threshold, t=10, then the state of the network is stable in the absence of any addition or deletion of anymore files, since the protocol will not act to redistribute files for any imbalances less than the threshold value of t=10.

In the resultant balanced resources in the network, there is lower latency in file searches and higher availability of data. One effect of the re-distribution is that loads during file searching and downloaded are more evenly distributed between peer computers.

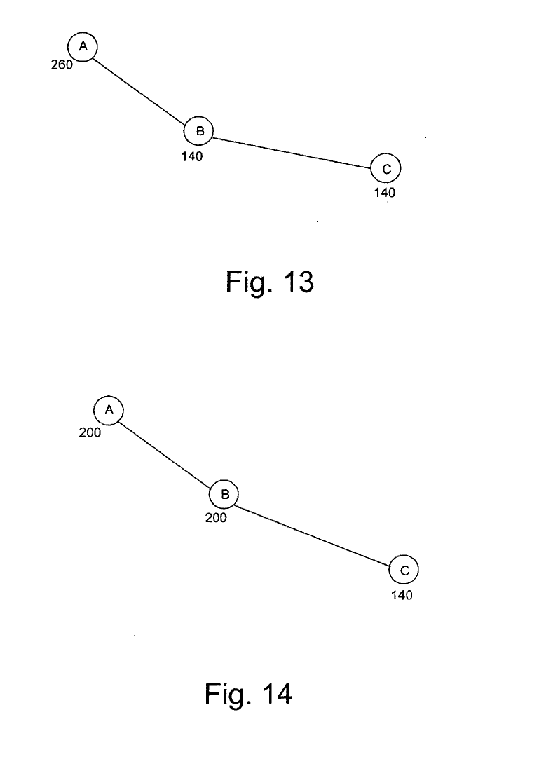

Referring to FIG. 13 herein, there is shown schematically three computer entities A, B, C, for example the three computer entities in the network shown in FIG. 3 herein, where file balancing between three computer entities only is considered, in the absence of any further balancing with any other computers in the network. After an initial balancing, computer A has 260 files, computer B has 260 files and computer C has 20 files. A further balancing between computers B and C may occur as follows. Computer B, initially having 260 files, communicates with computer C having 20 files. Computer C operates according to the protocol, to determine whether the imbalance of files between computers B and C is greater than a threshold value, in this case the threshold value being pre-set at 50. Since applying the condition:
|B−C|≧t is satisfied because

|260−20|=240, then the imbalance factor of 240 is greater than the threshold value, and consequently files are transferred from computer B to computer C. The number of files transferred is calculated as:
(260−20)/2=120.

A transfer of 120 files is made from computer B to computer C, resulting in 140 files on each of computers B and C. This condition is shown in FIG. 13 herein.

Referring to FIG. 14 herein, a further application of the protocol between computers A and B results in an initial condition of 260 files stored on computer A with 140 stored on each of computers B and C. Since the imbalance factor between A and B in this case is calculated −260−140|=120, which is above the threshold value 50, then a transfer of (260−140)/2=60 files is made resulting in 200 files of each of computer A and B as shown in FIG. 14 herein.

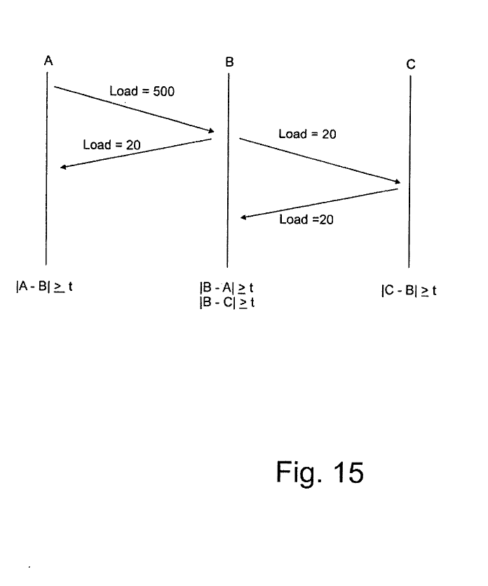

Referring to FIG. 15 herein, there is illustrated schematically an exchange of resource load messages between computers A, B, C as shown in FIG. 3 herein during a first application of the protocol when first computer A has a load of 500 files, second computer B has a load of 20 files, and third computer B has a quantity of 20 files. First computer A sends a load message to second computer B, notifying second computer B that first computer A has a load of 500 files. Second computer B returns to computer A a load message indicating that second computer B has a load of 20 files. Computer A then applies the protocol by calculating whether the difference A−B is greater than or equal to the threshold value t. Similarly, computer B calculates whether the imbalance between B and A i.e. the modulus of 20−500 is greater than or equal to the threshold value t.

The second application of the protocol between computers B and C, computer B sends a load message to computer C indicating that is has a local resource load of 20 files. Similarly, computer C sends to computer B another load message indicating that C has a load of 20 files. Computer B applies the protocol and determines a threshold value of the modulus of the loading B−C. Since each computer has 20 files, the modulus of B−C is 0, which is lower than the threshold value. Similarly, the third computer C calculates the modulus of the number of files of C minus the number of files on B which turns out in this case to be 0. Since this is below the threshold value, no transfer of files is initiated between computers B and C.

Many such processes occur between individual peer computers in the network asynchronously, resulting in an overall balancing of resources between computer entities in the network.

In peer to peer networks, some files are rarely updated. This favors a system as disclosed herein, in which resource balancing is achieved by duplication of resources, for example files. By duplication of resources throughout a network, availability of those resources is increased to all computers in the network. For example, by having a file resident on a plurality of computers, access to those files by other computers in the network will be easier then if the same file was stored on only one computer, since that one computer may effectively apply an accessibility restriction on that single file due to it limited bit rate capacity of its communications link or by going off line. This is overcome by distributing the file over a plurality of computer entities, so that a computer in the network can obtain the resource from any one of those plurality of computers storing the resource.

Further, the system disclosed herein, may be used to limit “free-riding”, Free-riding is a condition where a particular peer computer tends to always receive resources, i.e. uses the resources resident on other peer computers, but never sends out any resources itself, i.e. or rarely acts as a server to another peer computer within the network.

In the system disclosed herein, data describing a previous behaviour state of a computer entity is added to each peer computer. The previous behaviour can be added as an extension to a protocol for sharing resources. A part of the extension is used to negotiate locally a value of threshold t Another part of the extension achieves load sharing of resources between peer computers.

1. A method of balancing resources between a plurality of peer computer entities said method comprising:
determining an amount of a resource residing at said local peer computer entity;
determining an amount of said resource which resides on a neighbouring said peer computing entity;
assessing a difference between said locally resident resource and said amount of resource resident on said neighbouring peer computer entity; and
determining whether to initiate a transfer of resource between said local peer computer entity and said neighbouring peer computer entity.

2. The method as claimed in claim 1, wherein said process of assessing a difference in resources comprises:
determining a mathematical difference between an amount of said resource resident on said local computer entity and an amount of said resource resident on said neighboring computer entity; and
comparing an absolute value of said difference with a pre-determined threshold value.

3. The method as claimed in claim 1, wherein said process of assessing a difference in resources comprises:
determining a mathematical difference between an amount of said resource resident on said local computer entity and an amount of said resource resident on said neighboring computer entity; and
comparing an absolute value of said difference with a pre-determined threshold value;
wherein said threshold value is set at an amount which takes into account the capabilities of a local computer entity, said capability selected from the set:
a data storage capacity of said computer entity;
a bit rate capacity of a communications link connecting said computer entity.

4. The method as claimed in claim 1, comprising transferring a transferable said resource between said local peer computer entity and said neighboring peer computer entity.

5. The method as claimed in claim 1, wherein said determining an amount of a selected resource residing at said local peer computer entity comprises determining an amount of a transferable resource residing at said local peer computer entity.

6. The method as claimed in claim 1, wherein said determining an amount of said resource which resides on a neighboring said peer computer entity comprises determining an amount of a transferable resource which resides on a neighboring said peer computer entity.

7. The method as claimed in claim 1, wherein said amounts of resources at said local peer computer entity and said neighbouring peer computer entity respectively, comprise resources which are made available at said respective computer entities.

8. A computer entity configured for operating a method of balancing resources between a plurality of peer computer entities said method comprising:
determining an amount of a resource residing at said local peer computer entity;
determining an amount of said resource which resides on a neighbouring said peer computing entity;
assessing a difference between said locally resident resource and said amount of resource resident on said neighbouring peer computer entity; and.
determining whether to initiate a transfer of resource between said local peer computer entity and said neighbouring peer computer entity.

9. A protocol method for controlling a plurality of peer to peer connected computer entities to achieve resource balancing between said plurality of computer entities, said protocol comprising the processes of:
comparing an amount of a resource resident on a local computer entity, with an amount of a resource resident on a neighboring computer entity;
determining a difference in amount between said resource resident on said local computer entity and said resource resident on said neighboring computer entity; and
depending on a result of said determination initiating a resource transfer process between said local computer entity and said neighboring computer entity.

10. The protocol method as claimed in claim 9, further comprising processes for:
receiving at a local computer entity a set of data describing a status of a neighboring computer entity; and
storing said data describing said status of said neighboring computer entity at said local computer entity.

11. The protocol method as claimed in claim 9, comprising:
sending a resource transfer message between said peer computer entities, said resource transfer message requesting transfer of resources between said peer computer entities.

12. The protocol method as claimed in claim 9, comprising:
said local computer entity sending a message to said neighboring computer entity, said message comprising data stored by said local computer entity describing a status of said neighboring computer entity.

13. The protocol method as claimed in claim 9, comprising a process for:
said neighboring peer computer entity receiving a message containing data stored by said local peer computer entity, said data describing information stored by said local peer computer entity concerning a status of said neighboring computer entity;
said neighboring computer entity comparing said received status data with an actual status data describing an actual status of said neighboring computer entity; and
if said received data describing said status of said neighboring computer entity matches said actual status data describing a status of said neighboring computer entity within pre-determined limits, then sending a confirmation message to said local computer entity confirming that a transfer of resources between said local computer entity and said neighboring computer entity is authorized by said neighboring computer entity.

14. The protocol method as claimed in claim 9, comprising:
transferring a resource between said neighboring computer entity and said local computer entity by replication of said resource such that after said transfer, said resource resides in said local computer entity and on said neighboring computer entity.

15. The protocol method as claimed in claim 9, operable to control each said peer to actively seek to increase its holding of resources, subject to balancing out of resources amongst said plurality of computer entities.

16. A data storage media carrying computer program instruction data for controlling a first peer computer entity to perform the following operations:
determining an amount of a resource which resides at said first peer computer entity;
determining an amount of a resource which relies on at least one second peer computer entity;
assessing a difference between an amount of said resource resident on said first peer computer entity and an amount of said resource resident on said at least one second peer computer entity; and
depending upon the result of said assessment, initiating a transfer of said resources between said first peer computer entity and said at least one second peer computer entity.

17. Electronic data signals comprising computer program instructions data for controlling a peer computer entity to perform the following operations:
determining an amount of a resource which resides at a first peer computer entity;
determining an amount of a resource which is held on at least one second peer computer entity;
assessing a difference between an amount of said resource resident on said first peer computer entity and an amount of said resource resident on said at least one second peer computer entity; and
depending upon the result of said assessment, initiating a transfer of resources between said first peer computer entity and said at least one second peer computer entity.

18. A computer entity capable of operating in a peer to peer network environment, said computer entity comprising:
a communications port capable of communicating with at least one other computer entity over a communications link;
a data storage device capable of storing a transferable computing resource in the form of electronic data;
a resource balancing component capable of determining an amount of transferable resources resident on said computer entity, relative to an amount of resources resident on at least one other remote computer entity; and
a resource transfer component capable of effecting a transfer of resources between said computer entity and at least one other computer entity.

19. A network of peer to peer connected computer entities, each computer entity provided with a functional component for operating a peer to peer resource balancing protocol, said functioning component enabling each computer entity to meet the following conditions:
each peer computer entity in the network has access to information on an amount of resources available at one or a plurality of neighboring computer entities within said network;
each peer computer entity has the capability to determine an imbalance factor between an amount of resources resident at that peer computer entity, and an amount of resources resident at at least one other peer computer entity; and
each peer computer entity is provided with a capability to transfer resources between itself and at least one other neighboring computer entity.

20. The network as claimed in claim 19, wherein said each computer entity operate to attempt to increase the amount of resources which they maintain.

21. The network as claimed in claim 19, in which resources are transferred from one computer entity to another by replication of said resource.

22. The network as claimed in any one of claims 19, in which transfer of resources between computer entities is controlled by comparing an imbalance of said resources between pairs of said computer entities, with a threshold value of imbalance of resources.

23. The computer network as claimed in claim 19, wherein as least one said computer entity stores locally data describing a believed state of at least one other said computer entity of said network.

24. The network as claimed in claim 19, it which each said computer entity transmits to at least one other said computer entity in the network, a message describing the computer entity's own resource status.
